(19) United States
(12) Patent Application Publication
(10) Pub. No.: US 2021/0407240 A1
(43) Pub. Date: Dec. 30, 2021

(54) Fingerprint Security System

(71) Applicants: Samer Jaber, Niels, IL (US); Krystyn Jaber, Des Plaine, IL (US)

(72) Inventors: Samer Jaber, Niels, IL (US); Krystyn Jaber, Des Plaine, IL (US)

(21) Appl. No.: 17/336,497

(22) Filed: Jun. 2, 2021

Related U.S. Application Data
(60) Provisional application No. 63/043,677, filed on Jun. 24, 2020.

(51) Int. Cl. G07C 9/37; G07C 9/00; G06F 21/32; G08B 13/196; G06K 9/00

(52) U.S. Cl. CPC G07C 9/37; G07C 9/00944; G07C 2009/00992; G08B 13/1961; G06K 9/00892; G06F 21/32

(57) ABSTRACT

The present invention relates to a fingerprint security system comprised of a two layer lock, wherein a fingerprint scanner and a security camera are positioned on a first layer of the lock, and a keyhole is positioned on the second layer of the lock. The second layer of the lock is essentially a failsafe or backup feature, and is only operational in the event that the fingerprint scanner fails to operate as intended. The fingerprint scanner is used to identify authorized users, and allow only such authorized users to open the lock and access the locked property.

### CROSS-REFERENCE TO RELATED APPLICATION

The present application claims priority to, and the benefit of, U.S. Provisional Application No. 63/043,677, which was filed on Jun. 24, 2020 and is incorporated herein by reference in its entirety.

### FIELD OF THE INVENTION

The present invention relates generally to the field of security systems, namely locks. More specifically, the present invention relates to a dead bolt locking system that features a fingerprint scanner and a camera to provide an enhanced security system. The fingerprint scanner allows a user to access the otherwise locked property, and eliminates the need for the user to carry keys to unlock the entry door or entry point area. More specifically, the innovative lock of the present invention includes a key opening mechanism positioned behind the fingerprint scanner lock, which works as a failsafe or backup in case the fingerprint scanner does not function as intended or does not read the owner's fingerprint. Accordingly, the present disclosure makes specific reference thereto. Nonetheless, it is to be appreciated that certain aspects of the present invention are also equally applicable to other like applications, devices and methods of manufacture.

### BACKGROUND OF THE INVENTION

By way of background, security systems are used to prevent unauthorized access to any private premises, home, or any other item, such as luggage or the like. People leaving their home want their property and possessions to be safe while away. Also, even when at home, there are certain cabinets, drawers, doors, safes and the like, that need to be locked in order to keep the contents secure, and to prevent unauthorized individuals from accessing the same.

Historically, lock and key type security systems have been used by people around the world to lock their homes, luggage, drawers, cabinets, and the like to prevent unauthorized access to the same. However, with key operated locks, the owner is required to maintain possession of the key, and the loss of the same may prevent the owner from accessing his or her possessions or having to pay a locksmith to remove the lock to do so. Further, such conventional key based lock systems are not very secure, and an unauthorized person can easily gain access to the lock by destroying the lock, picking the lock, or creating a duplicate key for the lock.

Other keyless locks, such as combination locks, are also commonly used to secure a home, office, luggage, drawers, or the like. By way of background, a combination lock is opened by pressing a series of buttons on a keypad or by turning a dial to the correct sequence of numbers or letters. However, such entry codes or combinations are often forgotten, as users have no reliable method of remembering them. A written record of a preset code, particularly if kept in close proximity to a keypad, tends to be self-defeating. Further, this method is not particularly safe as any unauthorized person may hack the preset code and access the property, thereby causing loss to the property owner.

Still other locks, such as password locks, are used to protect offices, houses, personal property or the like. A password lock is similar to a combination lock, wherein a user may select a protected or secure password for the lock. Generally, users choose passwords which can be easily remembered by them, such as a birthday, pet name, nickname, or the like. Accordingly, by doing a little research on the owner, a potential intruder or other unauthorized party may be able to compile a short list of potential passwords, and use the passwords to open the password locks and access the property without the permission of the user.

The technology of biometrics has been advanced in recent years, and has made it feasible to employ such technologies to limit access to equipment, such as smartphones, to only authorized users. Further, biometrics have also been utilized for the identification of various individuals at places such as banks, offices or the like. While biometric-based authentication, such as fingerprint authentication, iris authentication, face recognition, etc., have been employed in the above referenced areas, the same has not been utilized in the field of lock security systems.

Therefore, there exists a long felt need in the art for a secure lock system that protects the user's property from any intruders and other unauthorized individuals. There is also a long felt need in the art for a secure lock system that can be used for doors, cabinets, drawers, luggage, or the like. Additionally, there is a long felt need in the art for a secure lock system for which users don't have to remember the passwords, or carry a key to obtain access to their locked possessions. Moreover, there is a long felt need in the art for a secure lock system which uses biometric based authentication technology to provide only authorized users with access to a premise or item or personal property. Further, there is a long felt need in the art for a secure lock system which also detects and identifies intruders and other individuals attempting to obtain unauthorized access to a locked item. Finally, there is a long felt need in the art for an enhanced security system that is relatively inexpensive to manufacture and both safe and easy to use.

The novel fingerprint security system of the present invention disclosed herein in various potential embodiments accomplishes all of the forgoing objectives, and provides a relatively reliable, safe, easy, and convenient solution to protecting a premise, item, luggage, valuable or the like from unauthorized access. The fingerprint security system of the present invention is also user friendly, since the solution does not require the user to carry a key for the lock or remember a password or combination to unlock the lock.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lock having a failsafe security access mechanism. More specifically, the lock comprises a fingerprint scanner, a security camera, and a failsafe key-based access mechanism positioned behind the fingerprint scanner structure. The lock utilizes an interior flip lock having a toggle capability which triggers a deadbolt-based lock to lock or unlock a door, cabinet, drawer, or the like based on input received from a user. The invention also offers a novel and effective lock design that prevents the entry of intruders and helps to reduce theft and/or any other malicious activity.

The subject matter disclosed and claimed herein, in another embodiment thereof, comprises a fingerprint-based padlock. The fingerprint-based padlock is comprised of a body having a first layer and a second layer. A fingerprint scanner is mounted on the first layer of the body of the padlock, as is a security camera. A keyhole structure is provided on the second layer of the body of the padlock, along with a deadbolt spring mechanism, a power source, a memory, a wireless transceiver, and a controller.

In a further embodiment of the present invention, the fingerprint-based lock can be used to protect commercial and residential property, thereby preventing unauthorized entry from intruders. The fingerprint scanner and camera enhance the security feature of the lock. The key access system on an internal layer of the body is utilized as a failsafe or backup feature, and is used in the unlikely event that the fingerprint scanner fails to function as intended, thereby still permitting the user to access his or her possessions.

In yet another embodiment of the present invention, a method of unlocking a secured premises or object using a fingerprint security system is disclosed. The method comprised the step of initially storing a plurality of fingerprints in the memory of a fingerprint operated lock. Next, a fingerprint is scanned using a fingerprint scanner on the lock supporting surface. The received fingerprint is then compared with the plurality of fingerprints stored in the memory. If the received fingerprint matches one or more of the stored fingerprints, the lock is unlocked. If, on the other hand, the scanned fingerprint does not match any of the stored fingerprints in the memory, the lock will not unlock, and the camera will take a photo of the unauthorized user and send the same to the owner in the form of a notification.

In yet another embodiment of the present invention, a method of accessing the failsafe fingerprint security system of the present invention is disclosed. The method comprises the steps of initially accessing a fingerprint scanner on a first layer of the body of the lock platform. Then, the system is triggered to open a second layer of the lock body in case the fingerprint scanner does not operate as intended. Once access to the second layer of the lock body has been provided, a user may unlock the lock itself by inserting a corresponding key into a key hole on the second layer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fingerprint security system of the present invention in accordance with the disclosed architecture;

FIG. 2 illustrates a perspective view of the key operation of one potential embodiment of the fingerprint security system of the present invention in accordance with the disclosed architecture;

FIG. 3 illustrates a perspective view of one potential embodiment of the fingerprint security system of the present invention attached to a door in accordance with the disclosed architecture;

FIG. 4 illustrates a perspective view of one potential embodiment of the fingerprint security system of the present invention, wherein a user is scanning his or her fingerprint in accordance with the disclosed architecture;

FIG. 5A illustrates a perspective view of a flip lock of one potential embodiment of the fingerprint security system of the present invention in accordance with the disclosed architecture, wherein the system is in the locked position;

FIG. 5B illustrates a perspective view of a flip lock of one potential embodiment of the fingerprint security system of the present invention in accordance with the disclosed architecture, wherein the system is in the unlocked position;

FIG. 6 illustrates a diagrammatic view of one potential embodiment of the various components of the fingerprint security system of the present invention in accordance with the disclosed architecture; and

FIG. 7 illustrates a flow diagram illustrating one potential embodiment of the various steps to be taken to open the lock of the fingerprint security system of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a secure lock system that protects a user's property, and that can be used for doors, cabinets, drawers, luggage, or the like. There is also a long felt need in the art for a secure lock system for which users don't have to remember a password, combination code, or necessarily carry a key to obtain access to the locked items. Moreover, there is a long felt need in the art for a secure lock system which uses biometric based authentication technology to provide only authorized users with access to the locked items, and which also detects and identifies intruders and other individuals attempting to obtain unauthorized access to the locked items. Finally, there is a long felt need in the art for an enhanced security system that is relatively inexpensive to manufacture and both safe and easy to use.

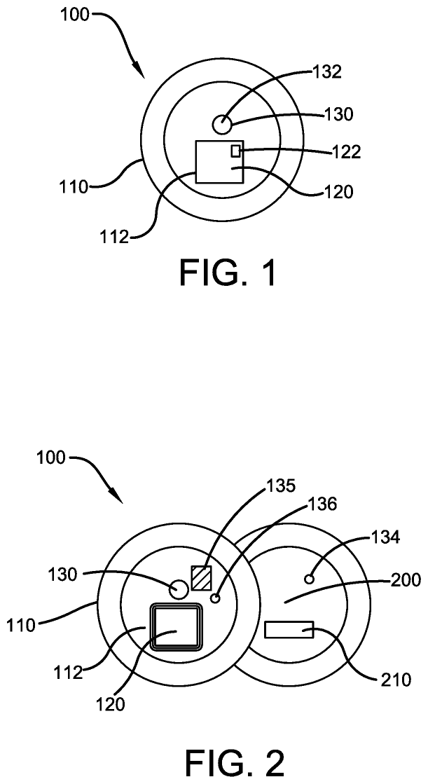

Referring initially to the drawings, FIG. 1 illustrates a perspective view of one potential embodiment of a fingerprint security system 100 of the present invention in accordance with the disclosed architecture. More specifically, the fingerprint security system 100 may be the form of a fingerprint operated padlock or other type of lock that is both comprised of a fingerprint-based authentication and a key based lock operation. The system 100 may have a geometric shape (e.g., rectangular, square, circular, etc.), and is comprised of a housing 110 having a first layer 112 and a second layer 200. The housing 110 also comprises an outer structure or body that may be manufactured from a durable metal, such as steel, iron, stainless steel, various alloys or the like, so that the same cannot be easily damaged to gain access to the locked items.

The first layer 112 of the housing 110 comprises a commercially available fingerprint scanner 120 and a security camera 130 for operating the lock system 100. The camera 130 further comprises a memory 132 and a transmitter 134 that has the ability to capture the image or video of an individual attempting to unlock the lock system 100 and wirelessly transmit the same to the owner's smart device, such as a smart phone, laptop, tablet, computer, etc., for playback. Said images and video may also be accompanied by a notification to the user from the lock that access has been attempted, as well as the results of the attempt.

The fingerprint scanner 120 may be of any known type of fingerprint sensor/scanner, such as a capacitive, optical or thermal sensor/scanner, and is mounted on a pre-selected area of the first layer 112 of the housing 110 of the lock system 100. The fingerprint scanner 120 is connected to a power source, such as one or more batteries 122, which may be placed inside the body 110 of the lock system 100 or its housing 110. Alternatively, the power source may be an active or direct current source. The fingerprint scanner 120 is also connected to a controller, memory 132, wireless communication module 134 and other components to enable the operation of the fingerprint security system 100 of the present invention, each of which may also be powered by the power source.

If a battery is used as the power source, the battery 122 may be a disposable battery or a rechargeable battery, and may be easily replaced or removed if necessary. Suitable batteries 122 include alkaline, nickel-cadmium, nickel-metal hydride, etc. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used.

A user may program the lock system 100 and record one or more fingerprints or other biometric details for one or more authorized users for the lock system 100. The fingerprint or other biometric details of the user are sampled and the minutia is extracted and stored as a data set in the memory 132. The recorded fingerprints or other biometric data are then used for further authorization to enable or disable access to various users of the lock system 100. The memory 132 may be an optional flash memory, which may be used to store fingerprint patterns or other biometric data indefinitely, even when the battery power is lost.

The security camera 130 is preferably integrated into the first layer 112 of the housing 110 of the lock system 100. The security camera 130 may be an image and/or video capturing camera to document any activities around the premises as well as the entry point of the property for which the lock system 100 is being used. The security camera 130 may also be a high-resolution camera having infrared night vision, high resolution video and wide-angle lenses. The first layer 112 may also include a speaker 135 and/or a microphone 136 for receiving voice commands as part of a biometric device and/or for verifying entry by, for example, speech recognition. The speaker 133 may also be used to provide a communication means to communicate between the individual at the entry point and another person remote from the entry point via the wireless transmitter 134.

In one embodiment, the security camera 130 may also be connected to a motion sensor, such that the camera 130 gets activated upon detection of any motion. The security camera 130 may also be used for 24/7 live recording of the premises or entry points. The security camera 130 may also be operated using a companion software application (not shown) of the lock system 100 that enables the user to remotely monitor the premises or other secured area. The images and/or videos captured by the security camera 130 may be stored in the memory 132 of the lock system 100. Alternatively, the security camera 130 may wirelessly store the video or image on a server, which may be located at the property or remote from the property. In a preferred embodiment, the security camera 130 may be connected to a face recognition sensor (not shown) to enable a facial authentication of a user for purposes of unlocking the lock system 100. In yet a preferred embodiment, the security camera 130 may also be used for purposes of iris recognition for authorization of users, as well as other biometric devices and data. Biometric devices used as part of the present invention include, but are not limited to, fingerprint scanners, facial recognition, retinal or iris scanners, hand scanners, speech recognition, or combinations thereof

FIG. 2 illustrates a perspective view of the key operation of one potential embodiment of the fingerprint security system 100 of the present invention in accordance with the disclosed architecture. More specifically, and as previously stated, the lock system 100 comprises a housing 110 having a first layer 112 and a second layer 200, as best shown on FIG. 2. The second layer 200 is an internal layer of the body 110 of the lock and can be accessed by sliding or opening the first layer 112 manually or as otherwise actuated remotely. The second layer 200 further comprises a manual device, such as a key actuated key hole 210, for using a key (not shown) to unlock the lock system 100, for example, in the unlikely event that the fingerprint scanner 120 (or any other biometric authentication system included with the lock system 100) doesn't function as intended. Nonetheless, the invention is not so limited and any other manual unlocking device may be used to manually actuate the lock and unlock the same including, without limitation, toggles, switches, latches and the like or combinations thereof.

In a further embodiment, the security camera 130 remains operational in the unlikely event that the fingerprint scanner 120 (or any other biometric authentication system included with the lock system 100) doesn't function as intended, and allows the user to capture all the activities near the premises or entry point of the fingerprint operated lock 100. In this manner, the user can easily track and monitor the activities of any intruder or other unauthorized individual attempting to access or bypass the lock system 100.

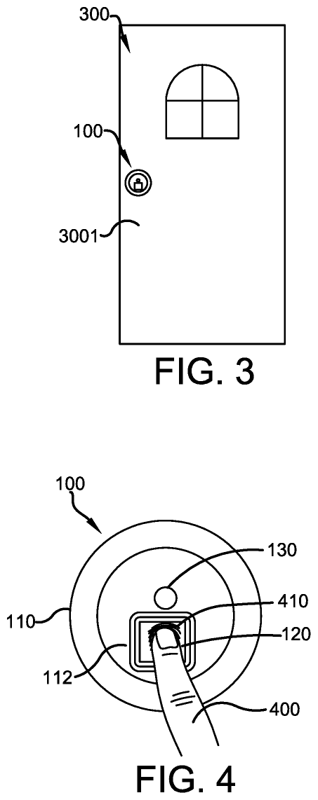

FIG. 3 illustrates a perspective view of one potential embodiment of the fingerprint security system 100 of the present invention attached to a door 300 in accordance with the disclosed architecture. More specifically, the fingerprint operated lock system 100 is attached to an exterior side 3001 of the door 300 at a conventional position, and at a height convenient to access the lock system 100 for opening or locking the door 300 or other access point 300. The convenient height for the installation of the fingerprint security system 100 on the door 300 may be, for example, 2 to 5 feet from the bottom of the door 300 or the floor.

To install the lock system 100 on the door, the user will install a hole or opening in the desired position that is configured to securely accommodate the lock system 100. The fingerprint operated lock system 100 is then installed in the opening of the door 100 by utilizing screws, nuts and bolts, or other fastening mechanisms. The fingerprint operated lock system 100 is connected to a stainless-steel deadbolt with a copper spring transmission for activating or deactivating the lock on the door 300. The deadbolt with copper spring works in coordination with the input received from the lock system 100 and opens the door 300 with a fingerprint match. The door 300 remains locked if the fingerprint of a user does not match with any of the fingerprints stored in the memory 132 of the lock system 100. The deadbolt itself may be comprised of any durable metal, and may be a single cylinder structure or a multiple cylinder structure.

FIG. 4 illustrates a perspective view of one potential embodiment of the fingerprint security system 100 of the present invention, wherein a user places his or her finger 400 on the fingerprint scanner 120 to scan his or her fingerprint 410 in accordance with the disclosed architecture. More specifically, a user touches the fingerprint scanner 120 using the outermost portion of his or her finger 400, and the fingerprint scanner 120 detects and reads the fingerprint 410 of the user. Upon capture, the fingerprint scanner 120 passes the received fingerprint 410 information to a controller having fingerprint matching data. The matching data information compares the detected fingerprint 410 with a set of pre-registered fingerprint details, and sends the result of the comparison to the controller for triggering an action in relation to the lock system 100. If the received fingerprint 410 matches any of the pre-registered authorized fingerprint data, the lock system 100 is opened, and the user can access the property or other area protected by the lock system 100. If, however, the received fingerprint 410 does not match any of the pre-registered authorized fingerprints, the lock system 100 remains locked. In such an instance, a notification, photo, video, alarm, warning, etc. can be sent wirelessly to the authorized user through a message, email or a companion software application via transmitter 134.

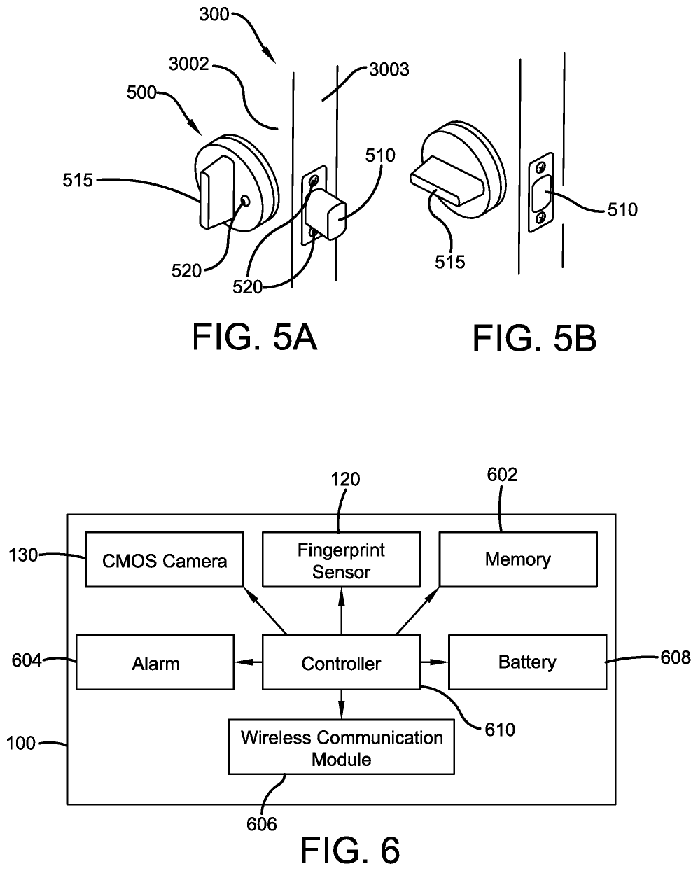

FIG. 5A illustrates a perspective view of a flip lock 500 of one potential embodiment of the fingerprint security system of the present invention in accordance with the disclosed architecture, wherein the lock system 100 is in the locked position. More specifically, a flip lock 500 is installed on an interior side 3002 of the door 300. The flip lock 500 may be a knob that may be rotated or flipped in a clockwise or a counter-clockwise direction to lock or unlock the lock system from inside the home, premises, office or the like. The flip lock 500 works in conjunction with a deadbolt 510 installed in between the flip lock 500 and the lock system 100, and along the edge 3003 of the door 300. The lock or bolt 500 is slidable or movable between a first position and a second position. In the first position, the bolt is concealed within the door, and in the second position the bolt or lock is extended out from the edge of the door and into an opening in a door jamb. The bolt 500 is movable by a toggle 515 on the interior of the premises, which is connected to the bolt 500. The deadbolt 510 may be comprised of a stainless steel or any other durable metal or material which is not easily defeated. The deadbolt 510 may be a single cylinder structure, or a multiple cylinder structure which works with a spring transmission mechanism.

The spring used with the deadbolt 510 may be made up of copper, or any other suitable material. For example, the flip lock 500, when rotated in the clockwise direction, may trigger the spring transmission to push the deadbolt 510 inside the wall attached to the edge 3003 and prevent the door from opening. By comparison, the flip lock 500, when rotated in the counter-clockwise direction, may trigger the spring transmission to reposition the deadbolt 510 back inside the door 300 structure along the edge 3003, and allow the door to open and close, as best shown in FIG. 5B.

FIG. 6 illustrates a diagrammatic view of one potential embodiment of the various components of the fingerprint security system 100 of the present invention in accordance with the disclosed architecture. More specifically, the lock system 100 includes a fingerprint scanner 120, a controller 610 to control and monitor operations of various components of the lock system 100, a memory 602, a security CMOS camera 130, an alarm 604, a wireless communication module 606 and a battery 608 for powering the lock system 100. The lock 100 may be used to secure or control access to any secured area, device, or information, such as an airport boarding area, building, stadium, database system, locked door, or other system or device. Further, the controller 610 is configured for comparing the sensed fingerprint or other biometric information gathered by the fingerprint scanner 120 with known characteristics of a person stored in the memory 602 to identify the person via a biometric signature data. The controller 610 may include any number of processors, controllers, integrated circuits or programmable logic devices. Memory 602 may contain, store, communicate, propagate or transport the program for use by or in connection with the instruction execution system, apparatus or device. Memory 602 may be one or more of a random-access memory (RAM), a read-only memory (ROM), an erasable, programmable, read-only memory (EPROM or Flash memory), a portable computer diskette or a portable compact disk read-only memory (CDROM).

Furthermore, the photos and videos captured by the camera 130 may be stored in the memory 602 and/or transmitted to a remote user's smart device. The controller 610 may also configure an alarm 604 to produce a sound or a notification on a display to notify a user after a maximum number of attempts to unlock the lock system 100 have taken place within a period of time, or after a maximum number of consecutive incorrect attempts. The battery 608 is used to provide electrical power and energy to the components of the system lock 100. Further, a wireless communication module 606, such as a Wi-Fi/Bluetooth SoC, NFC, RFID or infrared, may be used to control the lock system 100 using a companion smartphone application and/or to transmit captured images, videos and other data to a user and/or a cloud storage device associated with the lock system 100.

It is also contemplated that the lock system 100 can be connected to an IoT network through a communication technology, such as ZWave, Zigbee, Wi-Fi or the like, provided by the wireless communication module(s) 606. More specifically, the controller 610 may exchange data and other information among various different components within the lock system 100, or with various external devices, such as servers, cloud or systems via a network, such as the internet or a private link such as VPN. Nonetheless, it should be appreciated that the components shown in FIG. 6 are included to illustrate the basic functionality of the lock system 100, and that any other known components that increase the functionality and/or effectiveness of the lock system 100 can also be included. It should also be appreciated that in other embodiments, other biometric sensors, such as an IRIS scanner, face scanner or other security mechanisms, such as a PIN keypad, passcode, etc., may also be used along with the fingerprint scanner 120 to further enhance security or to add a layer of redundancy.

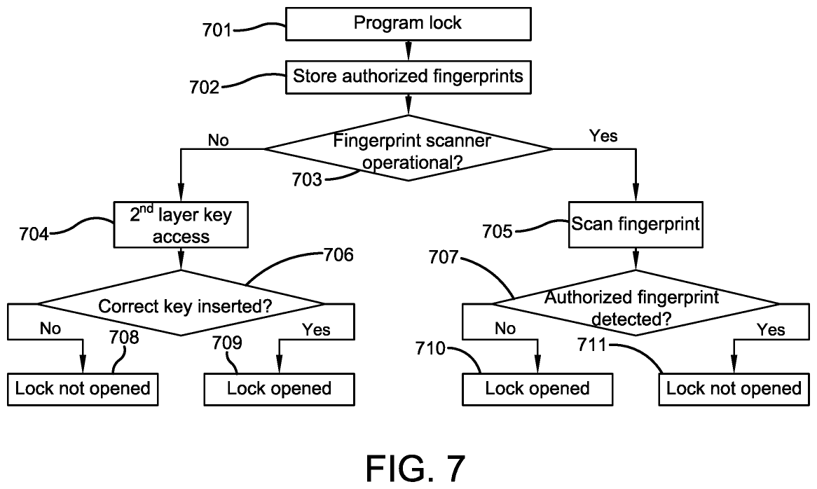

FIG. 7 illustrates a flow diagram illustrating one potential embodiment of the various steps to be taken to open the lock of the fingerprint security system 100 of the present invention in accordance with the disclosed architecture. More specifically, at step 701, the lock system 100 is programmed and installed for use and, at step 702, one or more authorized fingerprints are stored in the memory 132. At step 703, a determination is made as to whether the fingerprint scanner 120 is operational.

If the fingerprint scanner 120 is operational, a fingerprint scan of a user is obtained or captured at step 705. At step 707, the captured scan is compared with the authorized fingerprint scans stored in memory 132. If a match is found, the lock system 100 is unlocked at step 711. If, on the other hand, a match is not found, the lock is not unlocked at step 710 and the camera 130 may record an image or video of the person attempting to access the lock system 100, as described more fully above and transmit the same to the owner.

If on the other hand, the fingerprint scanner 120 is not operational, the user is permitted to access the second layer key access at step 704 where the user may insert his or her key at step 706. If the correct key is inserted, the lock system 100 is unlocked at step 709. If, on the other hand, a key is incorrect, the lock is not unlocked at step 708 and the camera 130 may record an image or video of the person obtaining to access the lock system 100, as described more fully above and transmit the same to the owner. In this manner, the lock system 100 of the present invention always maintains the security and provides key access as the failsafe or backup method.

The lock system 100 of the present invention is relatively easy to program with additional fingerprints, and may, in one embodiment, store up to 80 authorized fingerprints. The lock system 100 may also comprise a registration phase where the lock system 100 is programmed to register new authorized fingerprints to store in the memory of the lock system 100. In one embodiment, a notification of the registration of the new fingerprints is transmitted to a smartphone application associated with the lock system 100.

In another embodiment of the present invention, all of the data stored in the lock system 100 and that is transmitted from the lock system 100 to the user smartphone and/or cloud is encrypted using symmetric or asymmetric encryption. The lock system 100 may further employ “Minutia” or other similar matching processes for fingerprint matching by matching the ridges and valleys of the fingerprint, and has a very low false rejection rate (FRR). Further, the companion smartphone app can be used to delete authorized fingerprints from the memory of the lock 100, set specific time periods for certain fingerprints to open the lock 100, and modify the rights associated with certain fingerprints. The smartphone app can also be used to view the live or recorded video captured by the security camera built into the lock system 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fingerprint security system”, “fingerprint operated lock”, “lock”, “fingerprint-based lock”, and “fingerprint lock” are interchangeable and refer to the fingerprint security system 100 of the present invention.

Notwithstanding the forgoing, the fingerprint security system 100 of the present invention can be of any suitable size and configuration as is known in the art without affecting the overall concept of the invention, provided that it accomplishes the above stated objectives. One of ordinary skill in the art will appreciate that the size, configuration and material of the fingerprint security system 100 and its various components as shown in the FIGS. are for illustrative purposes only, and that many other sizes and shapes of the fingerprint security system 100 are well within the scope of the present disclosure. Although the dimensions of the fingerprint security system 100 are important design parameters for user convenience, the fingerprint security system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A security system comprising:
a lock having a slidable bolt that is repositionable between a first position and a second position, wherein the slideable bolt is repositioned by a toggle;
a biometric device for unlocking the lock upon receipt of an input from a user, wherein the biometric device is comprised of a memory in communication with a controller;
a security element; and
a backup device for unlocking the lock.

2. The security system as recited in claim 1, wherein the biometric device is one of a fingerprint scanner, a facial recognition scanner, a retinal or iris scanner, a hand scanner, a speech recognition device or a combination thereof.

3. The security system as recited in claim 1, wherein the backup device is a one of a toggle, a switch, a latch, or a combination thereof.

4. The security system as recited in claim 1, wherein the backup device is a key actuated release.

5. The security system as recited in claim 1, wherein the security system includes a first layer and a second layer.

6. The security system as recited in claim 5, wherein the biometric device is positioned on the first layer and the backup device is positioned on the second layer.

7. The security system as recited in claim 1, wherein the security element is a camera and the camera is in communication with the memory.

8. The security system as recited in claim 5 further comprising a transmitter, and wherein a security camera is positioned on the first layer.

9. The security system as recited in claim 7, wherein the camera is activated by motion and is in communication with a motion sensor.

10. The security system as recited in claim 1 further comprising a transmitter in wireless communication with a smart device.

11. A lock comprising:
a first layer comprising a security camera and at least one biometric device;
a second layer comprising a failsafe device;
a controller; and
a slidable bolt repositionable between a first position and a second position based upon receiving an instruction from the controller.

12. The lock as recited in claim 11, wherein the at least one biometric device is one of a fingerprint scanner, a facial recognition device, a retinal or iris scanner, a hand scanner, a speech recognition device or a combination thereof.

13. The lock as recited in claim 11, wherein the security camera is activated by motion and is in communication with a motion sensor.

14. The lock as recited in claim 11, wherein the failsafe device is one of a toggle, a switch, a latch, a key actuated release or a combination thereof.

15. The lock as recited in claim 11 further comprising a memory, a speaker, a microphone and a transmitter, wherein the transmitter is in wireless communication with a smart device.

16. A method of using a security system comprising the steps of:
providing a lock at an entry point, wherein the lock comprises a first layer, a second layer, a memory, a biometric device, a camera, and a transmitter;
storing a plurality of biometric data in the memory for subsequent retrieval by the biometric device;
using the biometric device to collect a set of biometric data;
comparing the set of biometric data to the stored plurality of biometric data to determine if a match exists;
unlocking the lock if the match exists; and
refusing to unlock the lock if the match doesn't exist and using the camera to take a picture or a video of a surrounding area of the lock.

17. The method of using a security system as recited in claim 16 further comprising the step of transmitting the picture or the video to a remote device.

18. The method of using a security system as recited in claim 16 further comprising the step of providing a backup device for unlocking the lock.

19. The method of using a security system as recited in claim 16, wherein the biometric device is one of a fingerprint scanner, a facial recognition device, a retinal or iris scanner, a hand scanner, a speech recognition device or a combination thereof.

20. The method of using a security system as recited in claim 16, wherein the lock further comprises a controller.
